(19) United States
(12) Patent Application Publication
(10) Pub. No.: US 2002/0055292 A1
(43) Pub. Date: May 9, 2002

(54) Disc drive printed circuit board connector locating feature

(75) Inventors: Michael Alan Maiers, Longmont, CO (US); Robert Terry Haas, Longmont, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/029,099

(22) Filed: Oct. 19, 2001

Related U.S. Application Data
(60) Provisional application No. 60/245,963, filed on Nov. 3, 2000.

(51) Int. Cl. H01R 13/64

(52) U.S. Cl. 439/378

(57) ABSTRACT

A disc drive includes a locating feature for aligning an electrical connector of a printed circuit board relative to an outer dimension of the disc drive. A guide pin is formed on one of the electrical connector and a base plate of the disc drive, and the guide pin is received within an opening defined in the other of the electrical connector and the base plate to position the electrical connector relative to the base plate. In addition, a method of positioning an electrical connector of a printed circuit board includes the step of inserting a guide pin formed on one of the electrical connector and the base plate into an opening formed in the other of the electrical connector and the base plate to align the electrical connector with the base plate. The method further includes the step of fastening the printed circuit board to the base plate of the disc drive while the guide pin remains within the opening.

### CROSS REFERENCE TO RELATED APPLICATIONS

This application claims the benefit of U.S. provisional application Ser. No. 60/245,963, filed Nov. 3, 2000, entitled “Accurate Low Cost Connector Locating Feature.”

### FIELD OF THE INVENTION

This application relates to magnetic disc drives and more particularly to a connector locating feature and method for precisely positioning a connector of a printed circuit board relative to the outer dimensions of a disc drive.

### BACKGROUND OF THE INVENTION

Disc drives are data storage devices that store digital data in magnetic form on a rotating storage medium on a disc. Modem disc drives comprise one or more rigid discs that are coated with a magnetizable medium and mounted on the hub of a spindle motor for rotation at a constant high speed. Information is stored on the discs in a plurality of concentric circular tracks typically by an array of transducers (“heads”) mounted to a radial actuator for movement of the heads relative to the discs. Each of the concentric tracks is generally divided into a plurality of separately addressable data sectors. The read/write transducer, e.g. a magnetoresistive read/write head, is used to transfer data between a desired track and an external environment. During a write operation, data is written onto the disc track and during a read operation the head senses the data previously written on the disc track and transfers the information to the external environment.

Much of the electronics that are essential to the operation of the disc drive are mounted on a printed circuit board assembly (“PCBA”) that is typically fastened to a bottom surface or base plate of the disc drive. The PCBA includes electrical components that manage the operations of the disc drive including controlling the speed of the spindle and position of the actuator arms over the discs. Similarly, the PCBA also includes electrical components that interface with the computer's processor.

An electrical connector is typically mounted to the PCBA to provide an electronic hardware interface between the disc drive and the computer. The type of electrical connector used in a given disc drive is generally dictated by two factors: the size or form factor of the disc drive and the interface specification of the disc drive. The most common interface specification currently used in disc drives is the Advanced Technology Attachment (ATA) interface specification, sometimes referred to as IDE for Integrated Drive Electronics. The ATA specification defines the protocols used to transfer data between ATA compatible devices, such as between a disc drive and a host computer. Other possible interfaces include the Small Computer System Interface (“SCSI”) and the recently developed Serial ATA interface.

Current disc drives sizes or “form factors” predominantly fall into two different sizes: the 3.5 inch form factor disc drive and the 2.5 inch form factor disc drive, where the 2.5 inch disc drive is typically used in mobile computing environments such as in laptop computers. The term “form factor” refers to the disc drive industry standard that defines the physical, external dimensions or the “external envelope” of a particular drive.

As noted above, the type of PCBA connector used depends on both the form factor and the drive interface. For example, a 3.5 inch form factor disc drive having a standard ATA connector typically utilizes a 40-pin connector, often referred to as 3-in-1 connector, which is designed to mate with a corresponding female connector. Alternatively, a typical 2.5 inch form factor disc drive employs what is commonly referred to as a 50-pin ATA connector. Furthermore, because 2.5 inch disc drives are typically used in mobile computers, the 50-pin connector on the 2.5 inch drive must typically be plugged into a female connector mounted on a back plane of a drive bay in the mobile computer. Due to the size constraints of a mobile computer (or other environment where a 2.5 inch drive may be utilized), the 2.5 inch disc drive and the corresponding PCBA connector must be precisely located within the computer system so that the pins on the PCBA connector mate precisely with the sockets formed in the corresponding female connector.

Because it is highly desirable to ensure that a disc drive from one manufacturer will fit within a computer system from another manufacturer (i.e., that the pins on the PCBA connector from a first manufacturer will fit within the sockets found in another manufacturer's drive bay), the Small Form Factor (“SFF”) Specification has been adopted. The SFF Specification essentially prescribes the location of the PCBA connector relative to the known outer dimension or “external envelope” of a 2.5 inch disc drive. More specifically, the SFF Specification prescribes the location of a first pin relative to the external envelope of the disc drive. Once the location of the first pin is fixed, the remainder of the pins (which have a known spacing or “pitch”) are essentially located relative to the drive envelope so that a PCBA connector of a drive that meets the SFF Specification will fit within a drive bay of a computer system that similarly meets the SFF Specification.

In addition to the SFF Specification, it has become more common for larger disc drives (such as 3.5 inch drives) to also be placed within drive bays. For example, larger computer systems or (e.g., computer servers) are commonly configured with multiple “hot swappable” disc drives where a drive may be pulled from an externally accessible drive bay and replaced with another drive without shutting down the computer. Such drive bays similarly require a precise alignment between the female connector found in the drive bay and the PCBA connector on the disc drive. Thus, it has become increasingly important to manufacture disc drives having PCBA connectors that are precisely aligned relative to the outer dimensions or “envelope” of the drive, regardless of the drive form factor or interface specification of the drive.

Disc drive manufacturers have previously utilized a number of different manufacturing techniques to properly position the PCBA connector relative to the remainder of the disc drive. These techniques include precise mating of the PCBA connector to the printed circuit board itself, as well as precise mounting of the PCBA to the base plate of the disc drive. For instance, alignment features on the PCBA are often used to mate with corresponding features on the drive base plate. Additionally, mounting holes formed in the PCBA are formed with very close tolerances to provide a tight fit between the mounting screws and the mounting holes formed in the PCBA. Thus, manufacturers have previously attempted to indirectly control the location of the PCBA connector relative to the disc drive envelope by using alignment features and tight manufacturing tolerances between the PCBA and the drive base plate. That is, manufacturers have previously attempted to meet the SFF Specification (i.e., control the location of the PCBA connector) by controlling the location of the PCBA relative to the base plate.

While such indirect control of the position of the PCBA connector has previously proven to be capable of meeting the SFF Specification, it is understood that there are manufacturing tolerances within each step of the disc drive assembly. Thus, there is a first manufacturing tolerance when the connector is attached to the PCBA, and then a second manufacturing tolerance when the PCBA is fixed to the base plate of the disc drive. This tolerance “stack-up” can occasionally lead to disc drives having connectors that are misaligned according to the SFF Specification. Indeed, as noted above, a great deal of effort is placed on minimizing this tolerance stack-up by requiring the use of precision assembly techniques, such as the drilling of precision mounting holes in the PCBA. However, such precision techniques can increase the cost and the assembly time of a Small Form Factor disc drive.

Accordingly, there is a need for improving the accuracy of positioning a PCBA connector relative to a disc drive envelope while reducing the cost and time required to assemble such a disc drive. The present invention provides a solution to this and other problems, and offers other advantages over the prior art.

### SUMMARY OF THE INVENTION

The present relates to a disc drive having a printed circuit board assembly and an electrical connector that includes a locating feature for aligning the electrical connector relative to an outer dimension of the disc drive.

In accordance with one embodiment of the present invention, a disc drive includes a top cover, a base plate, and a printed circuit board attached to the base plate. The printed circuit board includes an electrical connector secured to an edge of the printed circuit board. A guide pin protrudes from one of the base plate and the electrical connector and is received within an opening defined in the other of the base plate and the electrical connector to position the electrical connector relative to the base plate. In a preferred embodiment, the opening comprises a slot defined in a bottom surface of the base plate and the guide pin protrudes from the electrical connector.

The bottom surface of the base plate may include a plurality of threaded openings that correspond with a plurality of oversized mounting holes formed in the printed circuit board so that threaded fasteners can be inserted through the oversized mounting holes and into the threaded openings to secure the printed circuit board to the base plate while the guide pin remains positioned within the opening.

The present invention can also be implemented as a method of positioning an electrical connector of a printed circuit board relative to a base plate of a disc drive, where the method includes the step of inserting a guide pin formed on one of the electrical connector and the base plate into an opening formed in the other of the electrical connector and the base plate of the disc drive to align the electrical connector with the base plate. The method further includes the step of fastening the printed circuit board to the base plate of the disc drive while the guide pin remains within the opening.

The present invention can further be implemented as a disc drive having a base plate and a printed circuit board attached to the base plate. The disc drive includes an electrical connector attached to one end of the printed circuit board, and the connector includes a plurality of data pins adapted to mate with a female connector in a computer system. The disc drive also includes means for aligning the electrical connector relative to the base plate so that the data pins will be received within corresponding sockets of the female connector when the disc drive is installed within the computer system. In one preferred embodiment, the disc drive includes means for securing the printed circuit board to the base plate, and the securing means are separate from the means for aligning the electrical connector relative to the base plate.

These and various other features as well as advantages which characterize the present invention will be apparent from a reading of the following detailed description and a review of the associated drawings.

### BRIEF DESCRIPTION OF THE DRAWINGS

FIG. 1 is a perspective view of a disc drive incorporating an embodiment of the present invention, with a top cover of the disc drive partially broken away.

FIG. 2 is an exploded perspective view of the disc drive of FIG. 1 specifically illustrating a bottom surface of a base plate of the disc drive, a printed circuit board assembly (PCBA), and an electrical connector that is secured to the PCBA prior to the PCBA being fastened to the disc drive base plate.

FIG. 3 is a further exploded perspective view of the disc drive of FIG. 1 illustrating a guide pin on the PCBA electrical connector aligned above a slot formed in the base plate.

FIG. 4 is a perspective view of the assembled disc drive of FIG. 1 with a portion cut away to illustrate the guide pin on the PCBA electrical connector as the guide pin is inserted within the slot formed in the base plate.

FIG. 5 is a perspective view of the assembled disc drive of FIG. 1 similar to FIG. 4 illustrating the guide pin on the PCBA electrical connector fully inserted within the slot formed in the base plate.

FIG. 6 is a flow diagram illustrating a process of aligning the electrical connector and securing the PCBA to the base plate.

### DETAILED DESCRIPTION

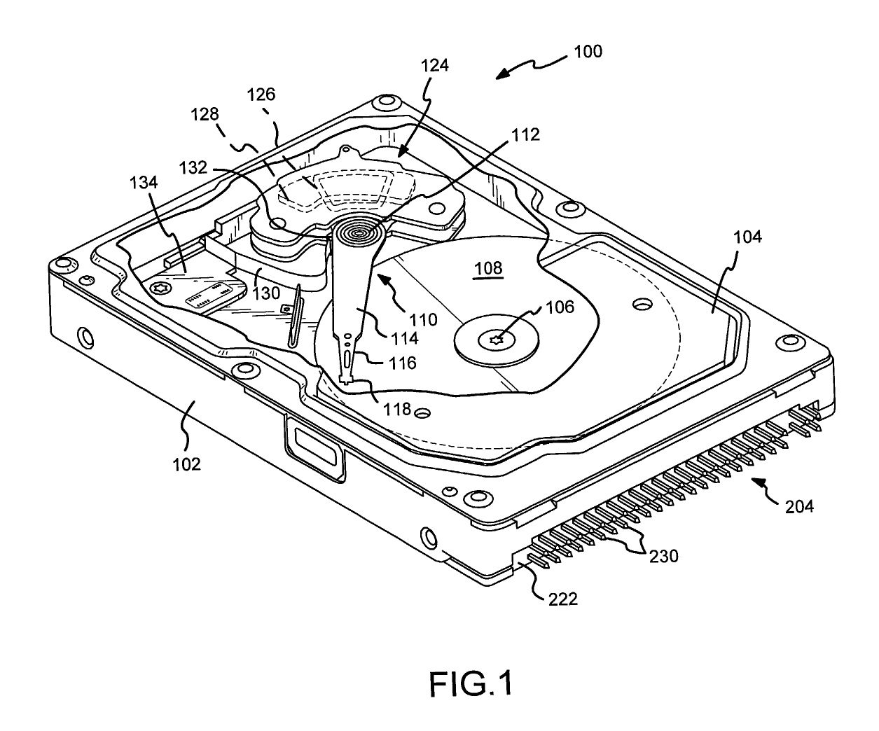

A disc drive 100 constructed in accordance with a preferred embodiment of the present invention is shown in FIG. 1. The disc drive 100 includes a base plate 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

The radial position of the heads 118 is controlled through the use of a voice coil motor 124, which typically includes a coil 126 attached to the actuator assembly 110, as well as one or more permanent magnets and return plates 128 which are spaced apart to establish a vertical magnetic field within which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112 and the heads 118 are caused to move across the surfaces of the discs 108.

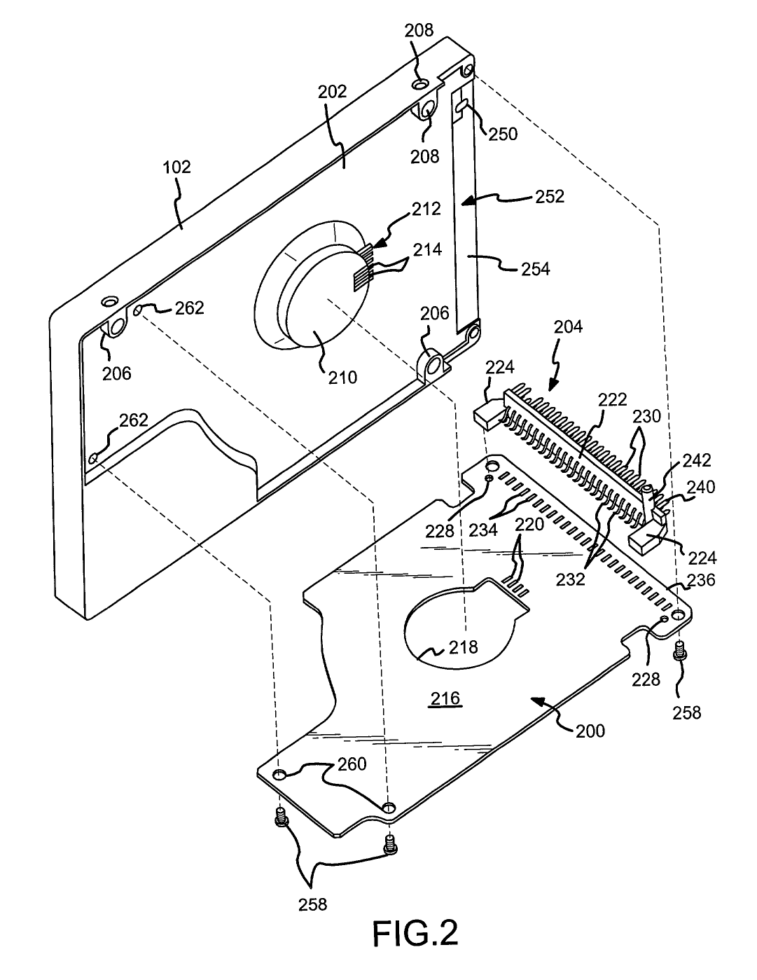

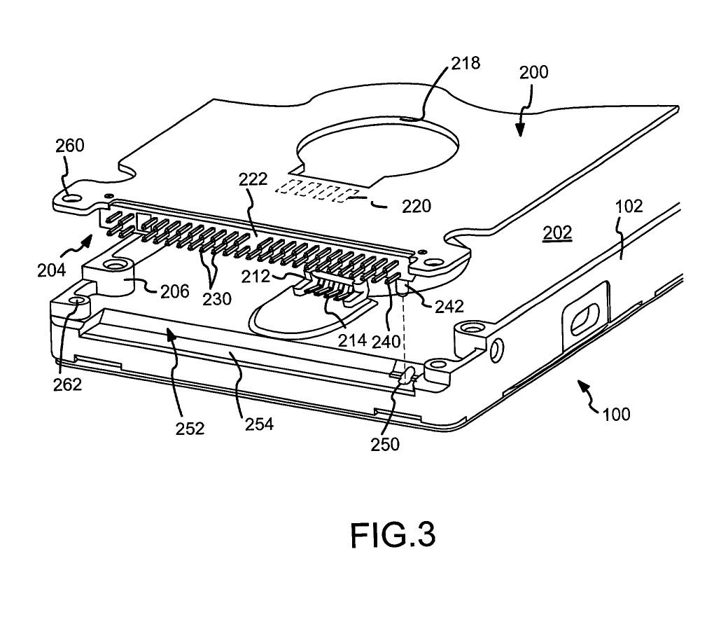

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and for amplifying read signals generated by the heads 118 during a read operation. The flex assembly terminates at a flex bracket 134 for communication through the base plate 102 to a disc drive printed circuit board assembly (“PCBA”) 200 (FIGS. 2 and 3) mounted to the bottom side of the disc drive base plate 102.

Referring now to FIG. 2, a bottom surface 202 of the base plate 102 is shown exploded from the PCBA 200. An electrical connector 204 is also shown exploded away from the PCBA 200. The bottom surface 202 of the disc drive base plate 102 includes a plurality of mounting pedestals 206 having a flat or planar mounting surface for the disc drive 100. Threaded holes 208 formed in each of the mounting pedestals 206 allow the disc drive 100 to be mounted either from below or from beside the disc drive 100. The bottom surface 202 of the base plate 102 also includes a formed circular region 210 for receiving a bottom portion of the spindle motor 106. A spindle motor connector 212 is attached at one end of the formed region 210 and includes a plurality of spring contacts 214 extending above or away from the bottom surface 202 of the base plate 102.

As further shown in FIG. 2, a top surface 216 of the PCBA 200 includes a keyhole-shaped opening 218 and a plurality of metal pads or contacts 220 positioned adjacent a flat end of the keyhole-shaped opening 218. The keyhole-shaped opening 218 allows the PCBA 200 to fit over the formed spindle motor region 210 of the base plate 102 and engage the spindle motor connector 212 when the PCBA 200 is secured to the bottom surface 202 of the base plate 102. The opening 218 allows the metal pads 220 on the top surface 216 of the PCBA 200 to engage the spring contacts 214 of the spindle motor connector 212. It is this contact between the pads 220 and the spring contacts 214 that supplies electrical power to the spindle motor 106.

The electrical connector 204 (FIG. 2) preferably comprises a vertically oriented pin supporting wall 222 formed from an electrically insulating material such as plastic. Two laterally oriented attachment tabs 224 are positioned at opposite ends of the pin supporting wall 222, and each tab 224 includes a downward protruding post (not shown) that corresponds with an opening 228 formed in the PCBA 200. The pin supporting wall 222 holds a plurality of pins 230 extending from a front surface of the wall 222. As the connector 204 shown in FIG. 2 comprises a 50-pin ATA connector, the pins 230 are a mixture of data and power pins. However, while an exemplary 50-pin ATA connector is shown in FIGS. 1-5, it is understood that different connectors 204 embodying various interface specifications (and thus various numbers and arrangements of pins 230) may be utilized with the present invention. A contact 232 corresponding to each pin 230 extends from a rear surface of the pin supporting wall 222. Each contact 232 defines a contact surface for engaging a corresponding pad 234 positioned on the top surface 216 along an edge 236 of the PCBA 200.

The connector 204 is attached to the PCBA 200 by first aligning the downward protruding posts (not shown) in the tabs 224 over the corresponding holes 228 in the PCBA 200 so that the contact surfaces of the contacts 232 engage the corresponding pads 234 on the PCBA 200. The posts are then preferably soldered in place within the holes 228 to secure the connector 204 to the PCBA 200. In some embodiments, the contacts 232 may be soldered to their corresponding pads 234 (such as through a reflow process) to ensure adequate electronic contact between the traces 232 and the pads 234. Additionally, alternative means for securing the connector 204 to the PCBA 200 are readily known to those skilled in the art.

While each of the pins 230 performs a specific function as defined by the respective interface specification (e.g., the ATA specification), one of the pins (i.e., a “first pin” 240) is typically designated for purposes of the Small Form Factor (“SFF”) Specification. That is, the SFF Specification expressly recites the position of the first pin 240 relative to the outer envelope of the disc drive. In order to ensure the proper position of the first pin 240 relative to the outer dimensions of the disc drive 100, the present invention utilizes alignment means positioned on the connector 204 itself as well as on the bottom surface 202 of the base plate 102. These alignment means preferably comprise a guide pin formed on one of the connector 204 and the base plate 102, and an opening formed on the other of the connector 204 and the base plate 102 to receive the guide pin. In the preferred embodiment of the invention shown in the drawing, the guide pin is formed on the connector 204 while the opening is formed on the base plate 102, however it is understood that the position of these features could be reversed and that the present invention encompasses the placement of the guide pin on the base plate 102 and the formation of the opening in the connector 204.

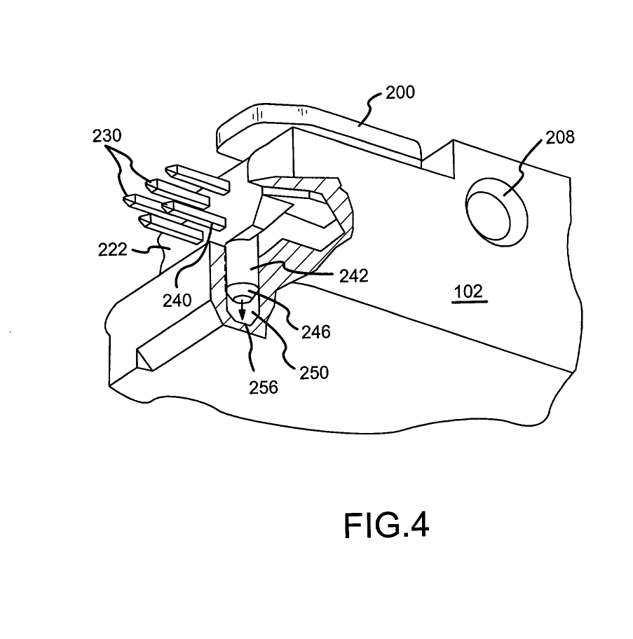

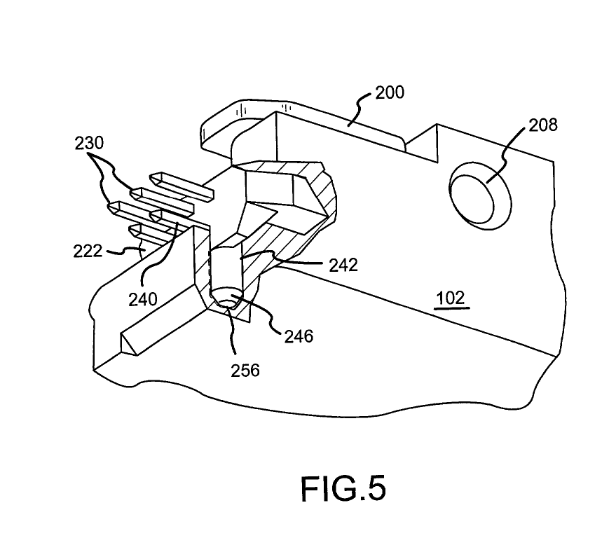

Specifically, FIG. 2 illustrates a guide pin 242 extending upward from a top surface of the pin supporting wall 222. The guide pin 242 is preferably cylindrical in shape and includes a chamfered tip 246 (FIGS. 4 and 5). The guide pin 242 is preferably formed from the same electrically insulating material used to form the connector 204 and, in a preferred embodiment, the guide pin 242 is molded together with the connector 204. Forming the guide pin 242 as an integral molded feature of the connector 204 ensures accurate placement of the guide pin 242 relative to the first pin 240 of the connector 204. Indeed, in one preferred embodiment of the present invention, the guide pin 242 is molded directly over the location of the first pin 240.

FIGS. 2 and 3 illustrate that the bottom surface 202 of the base plate 102 includes an opening 250 formed therein for receiving the guide pin 242. In one preferred embodiment, the opening 250 is formed as an elongated slot to ease insertion of the guide pin 242 within the opening 250. However, the present invention encompasses different shapes (e.g., a round hole) for the opening 250 other than the elongated slot shown in the drawing.

In one embodiment, the base plate 102 includes a recessed region 252 for receiving the connector 204, and the slot 250 is formed in an upper surface 254 of that recessed region 252. The slot 250 is substantially cylindrical in shape and includes a chamfered end 256 (FIG. 4) for receiving the chamfered tip 246 of the guide pin 242. Additionally, the slot 250 has a depth that is preferably slightly greater than a height of the guide pin 242 to ensure that the tip 246 of the pin 242 does not bottom out or contact the end 256 of the slot 250. See FIGS. 4 and 5 which illustrate cut away views of the guide pin 242 being received within the slot 250. In a preferred embodiment of the present invention, the slot 250 is formed as a cast feature of the cast aluminum base plate 102, although the slot 250 may alternatively be machined into the cast base plate.

During assembly of the disc drive 100, the guide pin 242 is inserted into the slot 250 to align the connector 204 (and specifically the first pin 240 of the connector) with the base plate 102 of the disc drive 100 prior to securing the PCBA 200 to the base plate 102. The guide pin 242 fits snugly within the slot 250 to provide precise positioning of the connector 204 relative to the base plate 102. Once the connector 204 has been properly positioned relative to the base plate 102, mounting screws 258 are then inserted through mounting holes 260 formed in the PCBA 200 and into threaded openings 262 formed in the bottom surface 202 of the base plate 102. The mounting screws 258 are then tightened down against the PCBA 200 while the guide pin 242 remains situated within the slot 250. While a single guide pin 242 is shown in FIGS. 1-3, it is understood that a second pin could be formed on the connector 204 to further aid in precisely positioning the connector 204 relative to the base plate 102. For example, a second pin may be desirable to prevent the connector 204 from rotating relative to the base plate 102 about an axis through the first pin 242. Thus, the present invention encompasses the use of one or more pins 242 mating with one or more openings 250. Furthermore, as described above, the location of the pin 242 and the opening 250 may be reversed relative to the preferred embodiment shown in the drawing by casting the pin 242 on the base plate 102 and molding the opening 250 in the connector 204.

The use of one or more guide pins 242 and a corresponding number of openings or slots 250 allows the position of the connector 204 to be determined relative to the base plate 102 (i.e., relative to the outer dimensions or “envelope” of the disc drive 100) with a high degree of accuracy before the mounting screws 258 fix the PCBA 200 to the base plate 102. Furthermore, because the mounting screws 258 and the mounting holes 260 are no longer used to establish the position of the connector 204 as in the prior art, the holes 260 can be formed in an “oversized” manner relative to the mounting screws 258 to prevent the screws 258 from binding against the sides of the oversized holes 260 during the mounting procedure. In the context of the present invention, the term “oversized” means that the size of the mounting hole 260 is sufficiently large to prevent contact between an edge of the hole 260 and a shaft of the mounting screw 258, but yet the hole 260 is smaller than a head of the mounting screw 258, thereby allowing the mounting screw 258 to effectively secure the PCBA 200 to the base plate 102 while not interfering with the fastening procedure. This represents an improvement over prior art SFF disc drives where the mounting hole in the PCBA is sized to closely match the diameter of the shaft of the mounting screw in order to precisely position the PCBA and thus the connector relative to the base plate of the disc drive. Where the mounting holes and screws are closely matched in size (as in the prior art), they tend to bind against one another thus increasing the time required to assemble the PCBA to the disc drive. The present invention thus provides an improvement in the manufacturing process of SFF disc drives.

As noted above, the use of the guide pin 242 and the opening or slot 250 provides for precise positioning of the connector 204 relative to the base plate 102. By directly positioning the connector 204 relative to the base plate 102 (as opposed to first positioning the connector 204 relative to the PCBA 200, and then positioning the PCBA 200 relative to the base plate 102), the present invention avoids the build up or “stacking” of tolerances that can reduce the positional accuracy of the PCBA connector. Additionally, because the pin 242 and the slot 250 are respectively molded or cast in place, the tolerances for both of these parts can be very tightly controlled during the molding or fabrication process.

As shown in FIGS. 3 and 4, the preferred embodiment of the guide pin 242 formed on the connector 204 is sufficiently long to allow the tip 246 of the pin 242 to be received within the slot 250 even before the PCBA 200 is compressed downward against the force of the spring contacts 214 on the spindle motor connector 212. That is, during assembly of the PCBA 200 to the base plate 102, the PCBA is initially suspended above the inverted base plate 102 by contact between the pads 220 on the PCBA 200 and the spring contacts 214 found on the spindle motor connector 212. The subsequent attachment of the mounting screws 258 serves to screw the PCBA 200 down flush against the bottom surface 202 of the base plate 102 while simultaneously compressing the spring contacts 214 against the pads 220 to ensure good electrical contact with the pads 220. During this process, the guide pin 242 remains in place within the slot 250 to control the positional accuracy of the connector 204 relative to the base plate 102. Indeed, the length of the guide pin 242 allows the connector 204 to be initially aligned when the PCBA 200 is first laid on the bottom surface 202 of the base plate 102, while the depth of the slot 250 allows the tip 246 of the guide pin 242 to move downward within the slot 250 as the mounting screws 258 secure the PCBA 200 to the base plate 102. See FIGS. 4 and 5.

As noted above, the depth of the preferred opening or slot 250 is preferably slightly greater than the length of the guide pin 242 to prevent the tip 246 of the pin from contacting the bottom end 256 of the slot 250 when the pin 242 is fully received within the slot 250 (FIG. 5). In this manner, the interaction between the guide pin 242 and the slot 250 does not interfere with the flush mounting of the PCBA 200 on the bottom surface 202 of the base plate 102.

In one preferred embodiment, the guide pin 242 may be positioned (i.e., molded) directly over the location of the first pin 240, while the slot 250 is correspondingly located (i.e., cast) within the base plate 102 of the disc drive. As noted above, the SFF Specification particularly specifies the location of the first pin 240 relative to the outer dimensions of the disc drive 100, and thus the highest degree of positional accuracy can be expected to be obtained by establishing the position of the pin 242 relative to the first pin 240. However, the present invention covers alternative positions for the pin 242 and the slot 250; including placing the pin 242 at the middle of the connector 204 or at an end of the connector opposite the first pin 240.

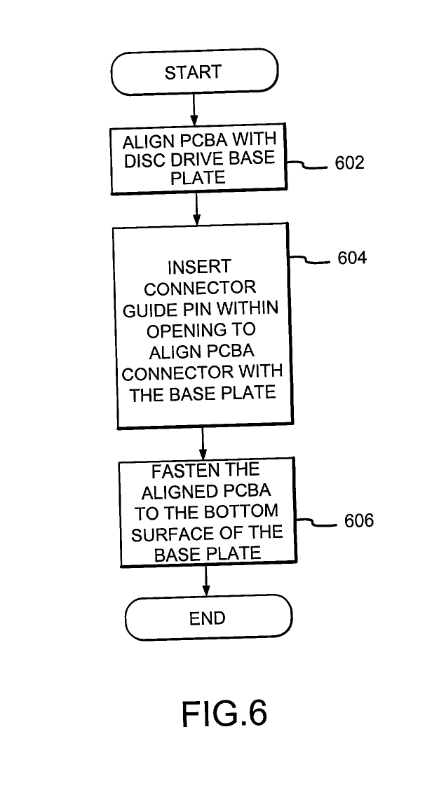

FIG. 6 illustrates a flow diagram of a preferred method of securing the PCBA 200 to the bottom surface 202 of the base plate 102 while ensuring that the connector 204 is properly positioned relative to the external disc drive dimensions pursuant to the SFF Specification. The method starts at step 602 where the PCBA 200 is aligned on the bottom surface 202 of the base plate 102 so that the pads 220 on the PCBA 200 loosely engage the spring contacts 214 on the spindle motor connector 212. At this time, the oversized mounting holes 260 formed in the PCBA 200 are roughly positioned over the threaded openings 262 formed in the bottom surface 202 of the base plate 102. In the next step 604, the tip 246 of the guide pin 242 is inserted within the slot 250 to precisely align the connector 204 relative to the base plate 102. As noted above, the pin 242 may be alternatively formed on the connector 204 or the base plate 102, although in the preferred embodiment shown in FIGS. 1-5 the pin 242 is formed on the connector 204. In one preferred embodiment, steps 602 and 604 may be combined together (i.e., the steps may be performed simultaneously) so that the oversized mounting holes 260 formed in the PCBA 200 are positioned over the threaded openings 262 formed in the base plate 102 at the same time that the guide pin 242 is received within the slot 250. In the next step 606, the mounting screws 258 are inserted through the mounting holes 260 and into the threaded openings 262 to tighten the PCBA 200 down against the bottom surface 202 of the base plate 102.

As noted above, the use of a guide pin 242 and a slot 250 as positioning means that are separate and distinct from the mounting screws 258 and the mounting holes 260 allows the present invention to utilize relatively large or “oversized” mounting holes 260. Thus, contrary to the prior art where close tolerances between the mounting screws and the mounting holes in the PCBA were necessary to properly align the PCBA connector, the present invention allows for a looser fit between the mounting screws 258 and the mounting holes 260 formed in the PCBA 200. That is, because the guide pin 242 remains within the slot 250 during the tightening step 606 (see FIGS. 4 and 5), the mounting screws 258 are not used to align the connector 204 but rather are only used to secure the PCBA 200 to the disc drive base plate 102. This provides an improvement in the manufacturing process since less time is required to secure the mounting screws 258 through the oversized mounting holes 260 in the PCBA 200.

While the present invention is illustrated with an exemplary 2.5 inch disc drive 100 having a 50 pin ATA connector, it is understood that the guide pin 242 or the opening 250 could be utilized with any type of connector (e.g., a SCSI or Serial ATA connector). Similarly, either the pin 242 or the corresponding opening 250 could be cast or machined into the base plate 102 of disc drives having varying sizes or “form factors” (e.g., a larger 3.5 inch drive or a smaller 1.8 inch drive). Furthermore, as noted above, it is understood that multiple pins 242 may be utilized in conjunction with multiple slots 250 in order to provide an even more precise positioning of the connector 204 relative to the base plate 102. While it is believed that a single guide pin 242 is sufficient to meet the stringent positioning requirements of the SFF Specification, the present invention encompasses the use of additional pins 242 and openings or slots 250 to increase the positional accuracy of the connector 204.

In summary, a disc drive (such as 100) in accordance with an exemplary preferred embodiment of the present invention has a top cover (such as 104), a base plate (such as 102), and a printed circuit board (such as 200) attached to the base plate (such as 102). The printed circuit board (such as 200) includes an electrical connector (such as 204) secured to an edge of the printed circuit board. A guide pin (such as 242) protrudes from one of the base plate (such as 102) and the electrical connector (such as 204), and the guide pin (such as 242) is received within an opening (such as 250) defined in the other of the base plate (such as 102) and the electrical connector (such as 204). The interaction between the guide pin (such as 242) and the opening (such as 250) positions the electrical connector (such as 204) relative to the base plate (such as 102). In one preferred embodiment, the opening (such as 250) is defined in a bottom surface (such as 202) of the base plate (such as 102), and the guide pin (such as 242) protrudes from the electrical connector (such as 204).

The bottom surface (such as 202) of the base plate (such as 102) preferably includes a plurality of threaded openings (such as 262), while the printed circuit board preferably includes a plurality of oversized mounting holes (such as 260) that correspond to the threaded openings (such as 262) so that threaded fasteners (such as 258) can be inserted through the mounting holes (such as 260) and into the threaded openings (such as 258) to secure the printed circuit board to the base plate (such as 102).

In preferred embodiments of the invention, the base plate (such as 102) is formed from cast aluminum while the opening (such as 250) is formed as a cast feature of the base plate. The opening (such as 250) may also be formed as a machined feature of the base plate (such as 102). Additionally, the electrical connector (such as 204) is formed from a molded plastic material and the guide pin (such as 242) is formed as a molded feature of the connector (such as 204).

Furthermore, in one preferred embodiment, the opening (such as 250) comprises an elongated slot, and the guide pin (such as 242) includes a chamfered tip (such as 246). A predetermined length of the guide pin (such as 242) is greater than a depth of the slot (such as 250) to prevent the tip (such as 246) of the guide pin (such as 242) from contacting a bottom surface (such as 256) of the slot (such as 250). Where the bottom surface (such as 202) of the base plate (such as 102) includes a spindle motor electrical connector (such as 212), and a top surface (such as 216) of the printed circuit board (such as 200) includes contact pads (such as 220) for engaging the spindle motor connector (such as 212), the length of the guide pin (such as 242) is sufficient to allow the tip (such as 246) to be received within the slot (such as 250) while the printed circuit board is suspended by contact between the printed circuit board contact pads (such as 220) and the spindle motor electrical connector (such as 212). In one preferred embodiment, the guide pin (such as 242) is positioned adjacent a predetermined data pin (such as 240) extending from the electrical connector (such as 204). In an alternative embodiment, the base plate (such as 102) includes a plurality of openings (such as 250) and the connector (such as 204) includes a plurality of guide pins (such as 242) to provide additional precision in aligning the connector (such as 204) relative to the base plate (such as 102).

In another exemplary preferred embodiment of the present invention, a method of positioning an electrical connector (such as 204) of a printed circuit board (such as 200) relative to a base plate (such as 102) of a disc drive (such as 100) includes the step (such as 604) of inserting a guide pin (such as 242) formed on one of the electrical connector (such as 204) and the base plate (such as 102) into an opening (such as 250) formed in the other of the electrical connector (such as 204) and the base plate (such as 102) of the disc drive to align the electrical connector (such as 204) with the base plate (such as 102). The method further includes the step (such as 606) of fastening the printed circuit board (such as 200) to the base plate (such as 102) of the disc drive (such as 100) while the guide pin (such as 242) remains within the opening (such as 250).

In yet a further exemplary preferred embodiment of the present invention, a disc drive (such as 100) includes a base plate (such as 102) and a printed circuit board (such as 200) attached to the base plate (such as 102). The disc drive (such as 100) includes an electrical connector (such as 204) attached to one end of the printed circuit board (such as 200), and the connector (such as 204) includes a plurality of data pins (such as 230) adapted to mate with a female connector in a computer system. The disc drive (such as 100) also includes means (such as 242 and 250) for aligning the electrical connector (such as 204) relative to the base plate (such as 102) so that the data pins (such as 230) will be received within corresponding sockets of the female connector when the disc drive (such as 100) is installed within the computer system. In one preferred embodiment, the disc drive (such as 100) includes means (such as 258, 260 and 262) for securing the printed circuit board (such as 200) to the base plate (such as 102), and the securing means (such as 258, 260 and 262) are separate from the means (such as 242 and 250) for aligning the electrical connector (such as 204) relative to the base plate (such as 102).

It will be clear that the present invention is well adapted to attain the ends and advantages mentioned as well as those inherent therein. While a presently preferred embodiment has been described for purposes of this disclosure, numerous changes may be made which will readily suggest themselves to those skilled in the art. For example, while the guide pin 242 is described as being molded to the connector 204, it is understood that the pin 242 could also be attached to the connector 204 by other means (such as by adhesives or welding). Additionally, while the guide pin 242 is described as having a cylindrical shape with a chamfered end 246, it is understood that guide pins of varying shape may be used in accordance with the present invention provided that the pin fits snugly within a corresponding opening or receptacle 250 to provide a highly precise alignment between the connector 204 and the base plate 102 of the disc drive. Accordingly, all such modifications, changes and alternatives are encompassed in the spirit of the invention disclosed and as defined in the appended claims.

What is claimed is:

1. A disc drive comprising:
a top cover;
a base plate attached to the top cover;
a printed circuit board assembly (“PCBA”) attached to the bottom surface of the base plate;
an electrical connector secured to an edge of the PCBA;
a guide pin protruding from one of the base plate and the electrical connector; and
an opening defined in the other of the base plate and the electrical connector, wherein the guide pin is received within the opening to position the electrical connector relative to the base plate.

2. The disc drive of claim 1 wherein:
the opening is defined in a bottom surface of the base plate and extends vertically upward toward the top cover; and
the guide pin protrudes from the electrical connector and extends vertically upward to fit within the opening defined in the base plate.

3. The disc drive of claim 2 wherein:
the bottom surface of the base plate includes a plurality of threaded openings;
the PCBA includes a plurality of oversized mounting holes corresponding to the threaded openings in the base plate; and
the PCBA is attached to the bottom surface of the base plate by a plurality of threaded fasteners that extend through the oversized mounting holes while the guide pin is received within the opening.

4. The disc drive of claim 2 wherein:
the base plate is formed from cast aluminum; and
the opening is formed as a cast feature of the base plate.

5. The disc drive of claim 2 wherein:
the base plate is formed from cast aluminum; and
the opening is machined into the base plate.

6. The disc drive of claim 2 wherein the electrical connector is formed from a molded plastic material and the guide pin is formed as an integral molded feature of the electrical connector.

7. The disc drive of claim 6 wherein:
the opening in the base plate comprises an elongated slot; and
the guide pin includes a chamfered tip.

8. The disc drive of claim 7 wherein:
the guide pin has a predetermined length; and
the elongated slot has a predetermined depth that is greater than the predetermined length of the guide pin to prevent the tip of the guide pin from contacting a bottom surface of the slot.

9. The disc drive of claim 8 wherein:
the bottom surface of the base plate includes a spindle motor electrical connector;
a top surface of the PCBA includes contact pads for engaging the spindle motor electrical connector; and
the predetermined length of the guide pin is sufficient to allow the tip of the guide pin to be received within the slot while the PCBA is suspended above the bottom surface of the base plate by contact between the PCBA contact pads and the spindle motor electrical connector.

10. The disc drive of claim 2 wherein:
the electrical connector includes a plurality of data pins extending laterally from a front surface of the connector; and
the guide pin is positioned adjacent a predetermined one of the data pins.

11. The disc drive of claim 2 wherein:
the base plate defines a plurality of openings extending vertically upward toward the top cover; and
the electrical connector includes a plurality guide pins extending vertically upward from the electrical connector, wherein each guide pin is received within a corresponding opening defined in the base plate to position the electrical connector relative to the base plate.

12. A method of positioning an electrical connector of a printed circuit board assembly (“PCBA”) relative to a base plate of a disc drive, the method comprising steps of:
(a) inserting a guide pin formed on one of the electrical connector and the base plate into an opening formed in the other of the electrical connector and the base plate to align the electrical connector with the base plate; and
(b) fastening the PCBA to the base plate of the disc drive while the guide pin remains within the opening.

13. The method of claim 12 wherein the guide pin is formed on the electrical connector and the opening is formed in the base plate of the disc drive.

14. The method of claim 13 further comprising a step (c) of aligning the PCBA with the base plate of the disc drive so that mounting holes formed within the PCBA are aligned with threaded openings formed in the base plate, prior to the fastening step (b).

15. The method of claim 14 wherein:
fastening step (b) further comprises inserting a threaded fastener through each of the mounting holes in the PCBA and into the corresponding threaded opening in the base plate; and
the mounting holes in the PCBA are oversized relative to a shaft of the threaded fastener to prevent the threaded fastener from binding against the PCBA.

16. The method of claim 14 wherein the base plate includes a spindle motor electrical connector and the PCBA includes contact pads for engaging the spindle motor electrical connector, and wherein:
aligning step (c) further includes aligning the PCBA contact pads with the spindle motor electrical connector, prior to the fastening step (b); and
the guide pin has a predetermined length sufficient to allow a tip of the guide pin to be received within the opening following the aligning step (c) and prior to the fastening step (b).

17. The method of claim 14 wherein the electrical connector is formed from a molded plastic material and the guide pin is formed as an integral molded feature of the electrical connector.

18. The method of claim 17 wherein:
the electrical connector includes a plurality of data pins extending laterally from a front surface of the connector; and
the guide pin is positioned adjacent a predetermined one of the data pins.

19. A disc drive including a base plate and a printed circuit board assembly (“PCBA”) attached to the base plate, the disc drive comprising:
an electrical connector attached to one end of the PCBA, the electrical connector having a plurality of data pins adapted to mate with a female connector in a computer system; and
means for aligning the electrical connector relative to the base plate so that the data pins will be received within corresponding sockets of the female connector when the disc drive is installed within the computer system.

20. The disc drive of claim 19 further comprising means for securing the PCBA to the base plate, and wherein:
the means for securing the PCBA to the base plate are separate from the means for aligning the electrical connector relative to the base plate.
